(19) United States
(12) Patent Application Publication
(10) Pub. No.: US 2023/0093751 A1
(43) Pub. Date: Mar. 23, 2023

(54) SYSTEMS AND METHODS FOR MONITORING THE STATUS OF A SHANK ATTACHMENT MEMBER OF AN AGRICULTURAL IMPLEMENT

(71) Applicant: CNH Industrial America LLC, New Holland, PA (US)

(72) Inventor: Brittany Schroeder, Lowell, IN (US)

(73) Assignee: CNH Industrial America LLC

(21) Appl. No.: 17/481,948

(22) Filed: Sep. 22, 2021

(51) Int. Cl. A01B 79/00; A01B 63/00; A01B 35/06; G01L 5/00

(52) U.S. Cl. CPC A01B 79/005; A01B 63/008; A01B 35/06; G01L 5/00

(57) ABSTRACT

A system for monitoring the installation status of shank attachment members of an agricultural implement includes a shank assembly having a shank extending between a proximal end and a distal end opposite the distal end, with the proximal end of the shank being configured to be coupled to a portion of the agricultural implement. The shank assembly also includes a shank attachment member configured to be coupled to the distal end of the shank. The system further includes a load sensor provided in operative association with the shank assembly and being configured to generate data indicative of a load transmitted through the shank assembly. In addition, the system includes a computing system communicatively coupled to the load sensor, with the computing system being configured to determine an installation status of the shank attachment member relative to the shank based on the data received from the load sensor.

### FIELD OF THE INVENTION

The present subject matter relates generally to agricultural implements and, more particularly, to systems and methods for monitoring the status of shank attachment members of an agricultural implement (e.g., the installation status of shank attachment members).

### BACKGROUND OF THE INVENTION

A wide range of agricultural implements have been developed and are presently in use for tilling, cultivating, harvesting, and so forth. Tillage implements, for example, are commonly towed behind tractors and may cover wide swaths of ground that include various types of residue. Such residue may include materials left in the field after the crop has been harvested (e.g., stalks and stubble, leaves, and seed pods). Good management of field residue can increase efficiency of irrigation and control of erosion in the field.

Tillers typically include ground-engaging tools, such as shanks and shank attachment members (e.g., shank points, chisels, etc.), configured to condition the soil for improved moisture distribution while reducing soil compaction from sources such as machine traffic, grazing cattle, and/or standing water. The shank attachment members are typically replaceable and come in a wide variety of configurations to accommodate different field conditions and desired results of the tilling operation. Unfortunately, when a shank attachment member falls off or otherwise decouples from its respective shank during operation, the shank attachment member is typically difficult to find and expensive to replace. In addition, the shank may also need to be replaced if the implement is operated for an extended period without a shank attachment member, which further increases the cost of a lost shank attachment member.

Accordingly, a system and method for improved monitoring of shank attachment members configured for use with an agricultural implement would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to a system for monitoring the installation status of shank attachment members of an agricultural implement. The system includes a shank assembly having a shank extending between a proximal end and a distal end opposite the distal end, with the proximal end of the shank being configured to be coupled to a portion of the agricultural implement. The shank assembly also includes a shank attachment member configured to be coupled to the distal end of the shank. The system further includes a load sensor provided in operative association with the shank assembly and being configured to generate data indicative of a load transmitted through the shank assembly. In addition, the system includes a computing system communicatively coupled to the load sensor, with the computing system being configured to determine an installation status of the shank attachment member relative to the shank based on the data received from the load sensor.

In another aspect, the present subject matter is directed to an agricultural implement including a frame and a plurality of shank assemblies supported relative to the frame. Each shank assembly includes a shank extending between a proximal end and a distal end opposite the distal end, with the proximal end of the shank being configured to be coupled to the frame. Each shank assembly also includes a shank attachment member configured to be coupled to the distal end of the shank. Additionally, the implement also includes a load sensor provided in operative association with a respective shank assembly of the plurality of shank assemblies and being configured to generate data indicative of a load transmitted through the respective shank assembly. The implement also includes a computing system communicatively coupled to the load sensor, with the computing system being configured to determine an installation status of the shank attachment member of the respective shank assembly based on the data received from the load sensor.

In a further aspect, the present subject matter is directed to a method for monitoring the installation status of a shank attachment member of an agricultural implement, with the agricultural implement comprising a shank assembly including a shank and a shank attachment member configured to be coupled to the shank. The method includes receiving, with a computing system, data indicative of a load being transmitted through the shank assembly; determining, with the computing system, when a change in the installation status of the shank attachment member occurs based on the data; and initiating, with the computing system, a control action when it is determined that a change in the installation status of the shank attachment member has occurred.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of an agricultural implement in accordance with aspects of the present subject matter;

FIG. 2 illustrates a side view of a shank assembly of the agricultural implement shown in FIG. 1, particularly illustrating the shank assembly including a sensor configured to generate data indicative of the loads being transmitted through the shank assembly in accordance with aspects of the present subject matter;

FIG. 3 illustrates a schematic view of one embodiment of a system for monitoring the installation status of shank attachment members of an agricultural implement in accordance with aspects of the present subject matter; and

FIG. 4 illustrates a flow diagram of one embodiment of a method for monitoring the installation status of shank attachment members of an agricultural implement in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In general, the present subject matter is directed to systems and methods for determining the status of shank attachment members of an agricultural implement, such as the installation status or presence of a shank attachment member on an associated shank. Specifically, in several embodiments, a computing system may be configured to receive data from one or more sensors configured to generate data indicative of the presence of a shank attachment member. For example, an agricultural implement may include a plurality of shank assemblies, with each shank assembly including a shank and a shank attachment member configured to be coupled to a distal end of the shank. In such an embodiment, the agricultural implement may also include one or more sensors for detecting the presence of one or more of the shank attachment members. For instance, in one embodiment, a load sensor(s) may be provided in operative association with each shank assembly that detects the load applied through the shank assembly. In such an embodiment, it may be determined when a given shank attachment member(s) has fallen off or otherwise become decoupled from its associated shank based on variations in the monitored load, such as a change in the magnitude and/or direction of the monitored load.

Regardless of the sensor configuration, the computing system may be configured to monitor an input from the associated sensor(s) to determine when a given shank attachment member is no longer installed on its respective shank. In response to such a determination, the computing system may, for example, indicate the status of the monitored shank attachment member(s) (e.g., via a user interface) to the operator, and/or initiate one or more other control actions, such as raising the frame of the implement and/or stopping the implement, based on the monitored status of the shank attachment member.

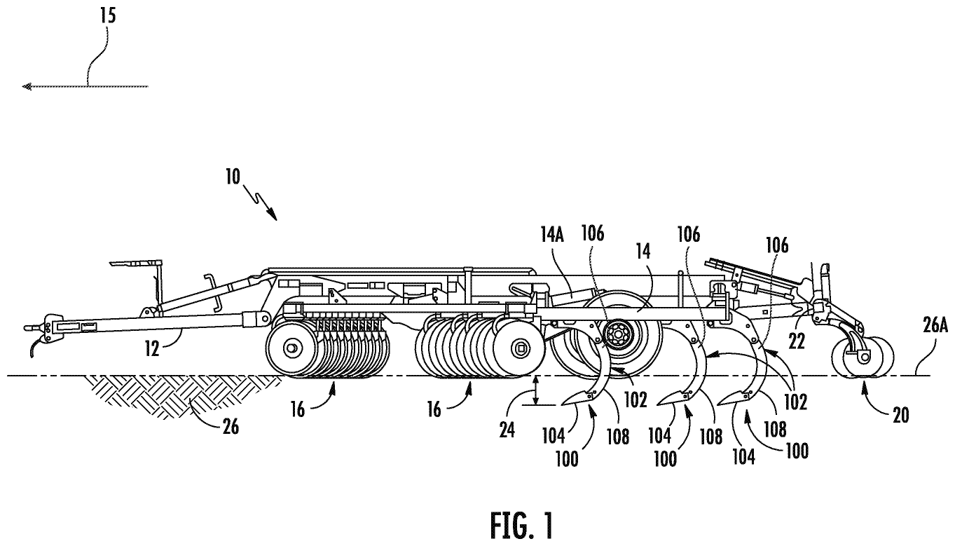

Referring now to the drawings, FIG. 1 illustrates one embodiment of an agricultural implement 10 in accordance with aspects of the present subject matter. In the illustrated embodiment, the agricultural implement 10 is configured as a tillage implement. However, in other embodiments, the agricultural implement 10 may correspond to any other suitable implement.

As is generally understood, the agricultural implement 10 may be used to till a field to prepare the soil by plowing, ripping, turning, and/or the like. In doing so, a portion of the soil residue, such as plant stalks and/or weeds, may be removed during the tilling process. In addition, the soil may be loosened and aerated, which in turn facilitates deeper penetration of crop roots. The tilling process may also help in the growth of microorganisms present in the soil and thus, maintain the fertility of the soil.

As shown in FIG. 1, the agricultural implement 10 includes a tow bar 12 having a coupling mechanism, such as a hitch, used to couple the implement 10 to a work vehicle, such as a tractor, for towing the implement across the field in a forward direction of travel (indicated by arrow 15). The agricultural implement 10 may also include a frame 14 and a plurality of ground-engaging tools coupled to or otherwise supported by the frame 14, such as one or more disk blades, plows, chisels, hoe openers, shank assemblies, rolling baskets, and/or the like. For instance, in the illustrated embodiment, the agricultural implement 10 includes a plurality of forward disc blades 16, a plurality of shank assemblies 100, and a plurality of soil-leveling discs 20 coupled to the frame 14, with the shank assemblies 100 being located aft of the forward disc blades 16 on the frame 14 and the soil-leveling discs 20 being positioned aft of the shank assemblies 100 on the frame 14 (e.g., via an associated tool bar 22). The frame 14 is configured to be actuated relative to the ground 26 between a raised position and a lowered or working position by one or more frame actuators 14A.

As shown in FIG. 1, in one embodiment, each shank assembly 100 may include both a shank 102 pivotally coupled to the implement frame 14 at one end (e.g., via associated attachment structure of the shank assembly 100) and a shank attachment member 104 coupled to the shank 102 at its opposed end. In the embodiment shown, each shank attachment member 104 corresponds to a shank point. As is generally understood, the shank points 104 may be configured to enable high-speed operation of the agricultural implement 10 while still producing a smooth soil surface. As shown in the illustrated embodiment, the shank assemblies 100 are positioned to till a field at a depth 24 below the field or ground surface 26A, with the depth 24 of the shank points 104 being adjustable by raising or lowering the shank assemblies 100 and/or the frame 14 (or portions thereof) relative to the field. For example, the depth 24 may be adjusted, as desired, based on local farming practices and/or field conditions. For purposes of discussion, the present subject matter will generally be described with reference to the illustrated shank points 104. However, it should be appreciated that, in other embodiments, each shank attachment member 104 may correspond to any other ground-engaging member configured to be coupled or attached to the distal end of a shank 102, e.g., chisels, hoe openers, and/or the like.

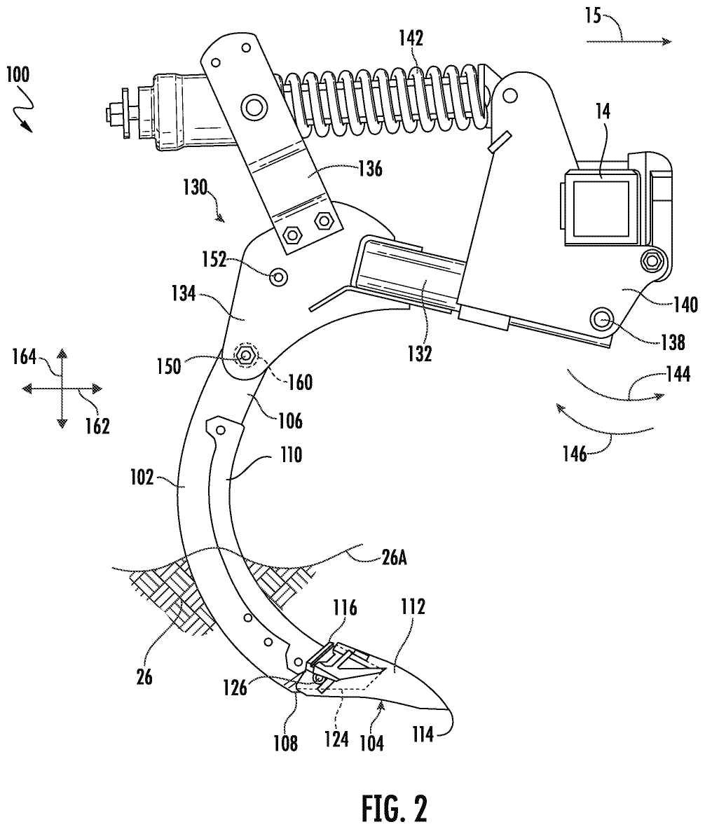

Referring now to FIG. 2, a side view of an example embodiment of a shank assembly 100 suitable for use with an agricultural implement (e.g., the agricultural implement 10 shown in FIG. 1) is illustrated in accordance with aspects of the present subject matter. It should be appreciated that, for purposes of discussion, the shank assembly 100 will be described with reference to the agricultural implement 10 shown in FIG. 1. However, those of ordinary skill in the art will readily appreciate that the disclosed shank assemblies 100 may be utilized with any suitable agricultural implements having any other suitable implement configuration(s).

In general, as shown in FIG. 2, the shank assembly 100 may include a shank 102 configured to be pivotally coupled to the implement frame 14 and a shank point 104 configured to be coupled to the shank 102. For instance, the shank 102 may extend lengthwise between a proximal end 106 and a distal end 108, with the proximal end 106 being configured to be coupled to the implement frame 14, e.g., via mounting structure 130 of the shank assembly 100, and the distal end 108 being configured to be coupled to the shank point 104. Additionally, in some embodiments, the shank assembly 100 may include a shin 110 configured to be coupled to the shank 102 above the shank point 104 to protect the shank 102 from wear.

The attachment structure 130 (e.g., first, second, and third attachment members 132, 134, 136) may generally be configured for pivotally coupling the shank 102 to the implement frame 14 (e.g., at a first pivot point 138). For instance, as shown in FIG. 2, a first attachment member 132 is pivotably coupled to a shank base frame 140, which, in turn, is rigidly or fixedly coupled to the implement frame 14 (e.g., a frame member of the frame 14). A second attachment member 134 is rigidly coupled to the first attachment member 132 for supporting the shank 102 relative to the frame 14 and a third attachment member 136 is rigidly coupled to the second attachment member 134 for coupling the shank 102 to a biasing element 142 of the shank assembly 100.

As shown in FIG. 2, in several embodiments, the biasing element 142 may be coupled between the frame 14 (e.g., via the shank base frame 140) and the attachment structure 130 for the shank assembly 100 (e.g., third attachment member 136) to bias the attachment structure 130 (and, thus, the shank 102 coupled thereto) to a predetermined ground-engaging tool position (e.g., a home or base position) relative to the frame 14. In general, the predetermined ground-engaging tool position may correspond to a ground-engaging tool position in which the shank 102 penetrates the soil to a desired depth. In several embodiments, the predetermined ground-engaging tool position may be set by a mechanical stop (not shown). In operation, the biasing element 142 may permit relative movement between the attachment structure 130 and the frame 14. For example, the biasing element 142 may be configured to bias the attachment structure 130 to pivot relative to the frame 14 in a first pivot direction (e.g., as indicated by arrow 144 in FIG. 2) until an end of the first attachment member 132 of the shank assembly 100 contacts the stop. The biasing element 142 may also allow the attachment structure 130 to pivot away from the predetermined ground-engaging tool position (e.g., to a shallower depth of penetration), such as in a second pivot direction (e.g., as indicated by arrow 146 in FIG. 2) opposite the first pivot direction 144, when the shank 102 encounters rocks or other impediments in the field. As shown in FIG. 2, the biasing element 142 corresponds to a spring. It should be recognized, however, the biasing element 142 may be configured as an actuator, hydraulic cylinder, or any other suitable biasing element.

As further illustrated in FIG. 2, the shank 102 may further be pivotably coupled to the attachment structure 130 of the shank assembly 100 at a second pivot point 150 to allow pivoting of the shank 102 relative to the attachment structure 130 about such pivot point 150 independent of the pivotal motion of the attachment structure 130 about the first pivot point 138. More particularly, as shown in the illustrated embodiment, the shank 102 is pivotally coupled to the second attachment member 134 of the attachment structure 130 at the second pivot point 150, which, in turn, is coupled to the frame 14 at the first pivot point 138 via the first attachment member 132. In such an embodiment, the shank 102 may be coupled to the second attachment member 134 via an associated pivot member (e.g., a pivot bolt or pin, which may include or be embodied by a load sensor as described below) extending through both the shank 102 and the attachment member 134 at the second pivot point 150.

Additionally, as shown in FIG. 2, the shank assembly 100 may further include a shear bolt or pin 152 (simply referred to hereinafter as a “shear pin” for simplicity purposes and without intent to limit) at least partially extending through both the second attachment member 134 and the shank 102 at a location separate from the pivot point 150 defined between such components. For instance, in the illustrated embodiment, the shear pin 152 is positioned above the pivot point 150 defined between the shank 102 and the adjacent attachment member 134. In general, the shear pin 152 may be configured to prevent rotation of the shank 102 relative to the attachment member 134 when the shear pin 152 is in an operable working condition or state, for instance when the shear pin 152 has not sheared or otherwise failed. In one embodiment, the shear pin 152 may correspond to a mechanical pin designed such that the pin breaks when a predetermined force is applied through the pin. For instance, the shear pin 152 may be designed to withstand normal or expected loading conditions for the shank 102 and fail when the loads applied through the pin 152 exceed or substantially exceed such normal/expected loading conditions.

Still referring to FIG. 2, the shank point 104 of the shank assembly 100 may generally include a body 112 extending lengthwise between a tip end 114 and an opposed retention end 116. In general, the tip end 114 of the shank point 104 may be configured to enable high-speed operation of the agricultural implement 10, while still producing a smooth soil surface 26A. For instance, in one embodiment, the orientation of the tip end 114 of the body 112 may be angled downwardly with respect to a horizontal plane of movement of the shank point 104 through the soil 26, which may reduce the overall amount of drag on the body 112 during operation of the implement 10. In addition, the tip end 114 of the body 112 may be substantially flat in the lateral or cross-wise direction of the body 112, thereby further reducing drag on the body 112. However, in other embodiments, the tip end 114 of the shank point 104 may have any other suitable configuration that allows the shank point 104 to generally function as described herein. Moreover, the retention end 116 of the body 112 may generally be configured to allow the distal end 108 of the shank 102 to be coupled to the shank point 104. For instance, in one embodiment, the body 112 includes a retention slot 124 defined therein for receiving the distal end 108 of the shank 102. A fastener 126 (e.g., a bolt or pin) is inserted through aligned openings in both the distal end 108 of the shank 102 and the shank point 104 to couple the point 104 to the shank 102.

During normal operation, the shank point 104 is retained in its installed state relative to the shank 102 (e.g., via the bolted or pinned connection) to allow the shank assembly 100 to function as intended. However, in certain instances, the shank point 104 may fall off of or may otherwise become decoupled from the shank 102. For example, when the fastener 126 coupled between the shank point 104 and the shank 102 breaks or fails, the shank point 104 is susceptible to becoming disengaged from the shank 102. In many instances, upon failure of the fastener 126, the shank point 104 will be maintained in its position relative to the distal end 108 of the shank 102 while the shank assembly 100 is at its working position due to the backwards force applied on the point 104 by the soil. However, when the implement 10 reaches the headlands and the shank assemblies 100 are raised out of the ground to make a headland turn, the shank point 104 will fall off due to the soil resistive force being no longer present. In other instances, the shank point 104 will simply decouple from the shank 102 during the performance of the tillage operation within the field, which may result in the point 104 being lost underneath the soil surface. Regardless, with the shank point 104 no longer installed on the shank assembly 100, the shank 102 will not properly function as intended (e.g., to fracture the hard pan and mix the soil), thereby reducing the agronomic output of the implement 10.

In accordance with aspects of the present subject matter, one or more sensors may be provided in operative association with each shank assembly 100 of the implement 10 to monitor the installation status of each shank point 104 relative to its associated shank 102. Specifically, in several embodiments, one or more load sensors 160 may be provided in operative association with each shank assembly 100 to monitor the loads applied through the shank assembly 100, which may, in turn, provide an indication of the installation status of the corresponding shank point 104. For instance, when the shank point 104 is installed on the shank 102, the load applied through the shank assembly 100 may generally be expected to have a magnitude falling within a given baseline load range and/or may generally be expected to be oriented in a given direction, such as by having a first expected load magnitude/direction when the shank assembly 100 is in the lowered position (e.g., with the shank point 104 being moved through the soil during the performance of a tillage operation) and a second expected load magnitude/direction when the shank assembly 100 is in the raised position (e.g., when the shank point 104 is raised out of the ground during a headlands turn). However, when the shank point 104 falls off or otherwise becomes decoupled from the shank 102, the magnitude and/or direction of the load applied through the shank assembly 100 will change, thereby indicating that the shank point 104 is no longer present on the shank 102. As will be described below, an associated computing system may be configured to continuously monitor the load applied through each shank assembly 100 based on the sensor data received from the load sensor 160 to detect load variations (e.g., in magnitude and/or direction) that are indicative of the shank point 104 being no longer installed on the shank 102. The computing system may then initiate one or more control actions, as desired, in response to determining that the installations status of the shank point 104 has changed.

As shown in FIG. 2, in one embodiment, a load sensor 160 may be installed at the interface or connection point between the shank 102 and the attachment structure 130 of the shank assembly 100. Specifically, as shown in the illustrated embodiment, the load sensor 160 may be provided at the pivot point 150 defined between the shank 102 and the second attachment member 134 of the attachment structure 134. The load sensor 160 may, in several embodiments, correspond to a load pin (e.g., a multi-axis load pin) configured to detect the load applied through the shank assembly 100 at the pivot point 150 in two or more directions, such as a horizontal x-axis (indicated by arrow 164) extending generally parallel to the direction of travel 15 of the implement 10 and a vertical y-axis (indicated by arrow 166) extending perpendicular to the x-axis 162 (and generally perpendicular to the surface 26A of the field). In such embodiments, the load sensor 160 may be configured to not only detect variations in the overall magnitude of the load applied through the pivot point 150, but may also detect variations in the directional component(s) of the load. It should be appreciated that, as an alternative to configuring the load sensor 160 as a load pin, the sensor 160 may correspond to any other suitable sensing device that can generate data indicative of the load applied through the shank assembly 100, such as a load cell (e.g., a donut load cell), a strain gauge, and/or the like.

By providing the load sensor 160 at the pivot point 150 as shown in FIG. 2, load variations may be detected in both the field and at the headlands that can provide an indication of a missing point 104. For instance, shank points typically have significant weight and, thus, when the shank assembly 100 is moved to the raised position when making a headland turn, a significant vertically downward load along the y-axis 164 is experienced at the pivot point 150 due to the combined weight of the shank 102 and point 104. However, if the shank point 104 has fallen off or is otherwise missing, the downward load applied along the y-axis 164 will be significantly less. This reduction in the downward load can be detected by the load sensor 160 and used as the basis for inferring or determining that the shank point 104 is no longer installed on the shank 102. Similarly, when the shank assembly 100 is in the lowered, working position and the shank point 104 is being pulled through the ground, a vertically downward load along the y-axis 164 is typically applied through the shank 102 due to the configuration of the point 104 as it cuts into the soil and pulls downwardly. In addition, a significant negative load along the x-axis 162 (i.e., a load applied in a direction opposite the direction of travel 15 of the implement 10) is typically applied through the shank 102 due to the resistive force applied on the point 104 via the soil. However, if the shank point 104 has fallen off or is otherwise missing while the shank assembly 100 is at its lowered position, the loads applied along the y-axis 164 and/or x-axis 162 will differ significantly from the normal, expected loads. For instance, without the point 104 cutting into the soil, the vertically downward load along the y-axis 164 will be reduced significantly. In fact, in certain instances, a shank 102 will experience a vertically upward load along the y-axis 164 without the downward pulling force generated by the point 104 due to its configuration and orientation within the soil.

It should be appreciated that, as an alternative to installing the load sensor 160 at the second pivot point 150, the load sensor 160 may be installed at any other suitable location on or within the shank assembly 100 that allows the load sensor 160 to generate data indicative of the load applied through the shank assembly 100. For instance, in one embodiment, a load sensor 160 (e.g., a stain gauge) may be installed on the shank 102 or a component of the attachment structure 130 to provide data indicative of the load applied through the shank assembly 100. In another embodiment, a load sensor 160 (e.g., a load pin or load cell) may be installed at the first pivot point 138 to provide data indicative of the load applied through the shank assembly 100.

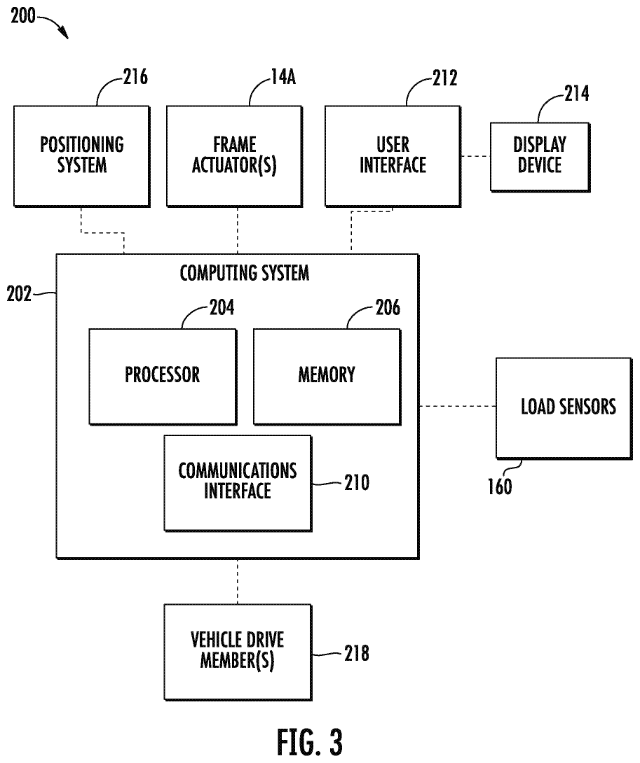

Referring now to FIG. 3, a schematic view of one embodiment of a system 200 for monitoring the status of shank attachment members of an agricultural implement (e.g., the installation status or presence of the shank attachment members) is illustrated in accordance with aspects of the present subject matter. In general, the system 200 will be described herein with reference to the agricultural implement 10 described above with reference to FIG. 1 and the shank assembly 100 described above with reference to FIG. 2. However, it should be appreciated by those of ordinary skill in the art that the disclosed system 200 may generally be used with agricultural implements 10 having any other suitable implement configuration and/or shank assemblies 100 having any other suitable shank configuration. For instance, although the system will be described with reference to the shank point 104 of FIG. 2, the system 200 may be used to monitor the installation status of any suitable shank attachment member have any other suitable configuration.

As shown in FIG. 3, the system 200 may include a computing system 202 configured to electronically control the operation of one or more components of the agricultural implement 10 and/or the work vehicle to which the implement 10 is coupled. In general, the computing system 202 may comprise any suitable processor-based device known in the art, such as a computing device or any suitable combination of computing devices. Thus, in several embodiments, the computing system 202 may include one or more processor(s) 204, and associated memory device(s) 206 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 206 of the computing system 202 may generally comprise memory element(s) including, but not limited to, a computer readable medium (e.g., random access memory RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 206 may generally be configured to store suitable computer-readable instructions that, when implemented by the processor(s) 204, configure the computing system 202 to perform various computer-implemented functions, such as one or more aspects of the methods and algorithms that will be described herein. In addition, the computing system 202 may also include various other suitable components, such as a communications circuit or module, one or more input/output channels, a data/control bus and/or the like.

It should be appreciated that, in several embodiments, the computing system 202 may correspond to an existing computing system 202 of the agricultural implement 10 and/or of the work vehicle to which the implement 10 is coupled. However, it should be appreciated that, in other embodiments, the computing system 202 may instead correspond to a separate processing device. For instance, in one embodiment, the computing system 202 may form all or part of a separate plug-in module that may be installed within the agricultural implement 10 and/or associated work vehicle to allow for the disclosed system and method to be implemented without requiring additional software to be uploaded onto existing control devices of the implement 10 and/or vehicle.

In some embodiments, the computing system 202 may be configured to include a communications module or interface 210 to allow for the computing system 202 to communicate with any of the various other system components described herein. For instance, in several embodiments, the computing system 202 may be configured to receive data from one or more sensors of the agricultural implement 10 that are used to monitor the status of the shank points 104, such as one or more of the load sensors 160 described above. The computing system 202 may be communicatively coupled to the sensor(s) 160 via any suitable connection, such as a wired or wireless connection, to allow data indicative of the installation status of the shank points 104 to be transmitted from the sensor(s) 160 to the computing system 202.

As will be described below, the computing system 202 may be configured to determine the installation status of each of the shank points 104 based on the data received from the sensors 160. For example, the computing system 202 may include one or more suitable algorithms stored within its memory 206 that, when executed by the processor 204, allow the computing system 202 to determine the installation status of the shank points 104 based on the data from the sensor(s) 160. The computing system 202 may be configured to monitor the installation status of each shank point 104 periodically, continuously, or only as demanded by an operator of the implement 10. For example, in some embodiments, the computing system 202 may collect data from the sensors 160 periodically based on some predetermined delay period or sampling frequency.

In several embodiments, the computing system 202 may be configured to determine the installation status of each of the shank points 104 by detecting variations in the load data received from the load sensor 160 installed relative to the associated shank assembly 100. As described above, the magnitude and/or the direction of the load applied through a given shank assembly 100 may vary based on the installation status of the associated shank point 104. For instance, with a shank assembly 100 moved to its raised position, a significant reduction in the downwardly oriented vertical load may be experienced when the shank point 104 has fallen off its associated shank 102. Similarly, with a shank assembly 100 moved to its lowered position, a significant change in the vertical and/or horizontal load (e.g., including a change in the direction of the vertical load) may be experienced when the shank point 104 has fallen off its associated shank 102.

These load variations may be detected by each load sensor 160 and subsequently used by the computing system 202 to determine when the installation status of a given shank point 104 has changed. For instance, the computing system 202 may be configured to compare the magnitude and/or direction of the monitored load to one or more associated thresholds and/or conditions selected so as to provide an indication as to whether a given shank point 104 is still installed on its respective shank 102. In such an embodiment, the threshold(s) and/or condition may vary depending on whether the load data was collected while the shank assembly 100 was at its lowered or raised position. For instance, one or more first thresholds and/or conditions may be used to analyze load data collected while the shank assembly 100 is at its lowered position, while one or more second thresholds and/or conditions may be used to analyze load data collected while the shank assembly 100 is at its raised position.

Further, in some embodiments, the computing system 202 may be configured to indicate the installation status (e.g., the presence or lack thereof) of each of the shank points 104. For example, in the embodiment shown in FIG. 3, the communications interface 210 may allow the computing system 202 to communicate with a user interface 212 having a display device 214, with the display device 214 being configured to display the installation status of one or more of the shank points 104. However, it should be appreciated that the computing system 202 may instead be coupled to any number of other indicators, such as lights, alarms and/or the like to provide an indicator to the operator regarding the installation status of the shank points 104.

Additionally, in several embodiments, the computing system 202 may be configured to indicate to an operator the location within the field at which each monitored shank point 104 falls off or otherwise becomes decoupled from its respective shank 102. For example, in the embodiment shown in FIG. 3, the computing system 202 is configured to be in communication with a positioning system 216 (e.g., a GPS-based positioning system), with the positioning system 216 being configured to identify the current location of the implement 10. In such an embodiment, the computing system 202 may be configured to monitor the current location of the implement 10 as it simultaneously monitors the installation status of each monitored point 104. When it is detected that a given point 104 is no longer installed relative to its respective shank 102, the computing system 202 may store the current field location of the implement 10 within its memory. The computing system 202 may then create an alert or log of alerts to indicate to an operator the location(s) of the missing shank point(s) 104 within the field, which may, for example, be displayed to the operator via the user interface 212.

In further embodiments, the computing system 202 may be configured to perform one or more implement-related control actions based on the determination of the installation status of the shank points 104. Specifically, in some embodiments, the computing system 202 may be configured to control one or more components of the agricultural implement 10 based on the determination of the installation status of the shank points 104. For example, as shown in FIG. 3, the computing system 202 may be configured to control one or more frame actuators 14A to move the implement frame 14 into its raised position when it is determined that one or more of the shank points 104 is missing.

Additionally or alternatively, in some embodiments, the computing system 202 may be configured to perform one or more vehicle-related control actions based on the determination of the installation status of the shank points 104. For example, as shown in FIG. 3, in some embodiments, the computing system 202 may be configured to control the operation of one or more drive components 218 configured to drive the vehicle coupled to the implement 10, such as the engine and/or the transmission of the vehicle. In such embodiments, the computing system 202 may be configured to control the operation of the vehicle drive component(s) 218 based on the determination of the installation status of the shank points 104, for example, to bring the vehicle and implement 10 to a stop when it is determined that one or more of the shank points 104 is missing.

It should be appreciated that, depending on the type of computing system 202 being used, the above-described control actions may be executed directly by the computing system 202 or indirectly via communications with a separate controller. For instance, when the computing system 202 corresponds to an implement controller of the implement 10, the computing system 202 may be configured to execute the implement-related control actions directly while being configured to execute the vehicle-related control actions by transmitting suitable instructions or requests to a vehicle-based controller of the vehicle towing the implement 10 (e.g., using an ISObus communications protocol). Similarly, when the computing system 202 corresponds to a vehicle controller of the vehicle towing the implement 10, the computing system 202 may be configured to execute the vehicle-related control actions directly while being configured to execute the implement-related control actions by transmitting suitable instructions or requests to an implement-based controller of the implement 10 (e.g., using an ISObus communications protocol). In other embodiments, the computing system 202 may be configured to execute both the implement-based control actions and the vehicle-based control actions directly or the computing system 202 may be configured to execute both of such control action types indirectly via communications with a separate controller.

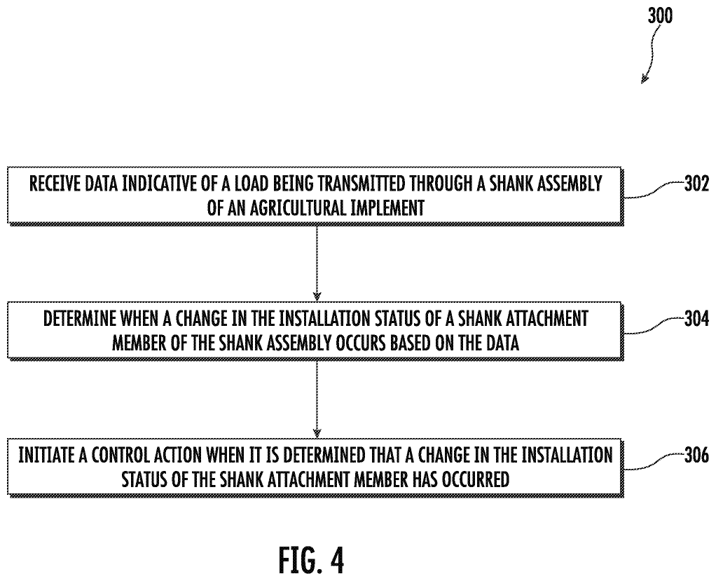

Referring now to FIG. 4, a flow diagram of one embodiment of a method 300 for monitoring an installation status of a shank attachment member of an agricultural implement is illustrated in accordance with aspects of the present subject matter. In general, the method 300 will be described herein with reference to the implement 10 and the shank assembly 100 shown in FIGS. 1 and 2, as well as the embodiment of the system 200 shown in FIG. 3. However, it should be appreciated that the disclosed method 300 may be executed with implements and/or shank assemblies having any other suitable configurations and/or with systems having any other suitable system configuration. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined and/or adapted in various ways without deviating from the scope of the present disclosure.

As shown in FIG. 4, at 302, the method 300 may include receiving data indicative of a load being transmitted through a shank assembly of an agricultural implement. For example, as indicated above, the computing system 202 may be communicatively coupled to one or more load sensors 160 configured to generate data indicative of the load being transmitted through a shank assembly 100. For instance, in one embodiment, the load sensor(s) 160 may correspond to a load pin installed at a pivot point between adjacent components of the shank assembly 100, such as the pivot point 150 defined between the shank 102 and the attachment structure 130 of the shank assembly 100.

Additionally, at 304, the method 300 may include determining when a change in the installation status of a shank attachment member of the shank assembly occurs based on the data. Specifically, as indicated above, the computing system 202 may be configured to monitor the load data received from the sensor(s) 160 to detect variations in the loads transmitted through the shank assembly 100 that may be indicative of the associated shank point 104 falling off or otherwise becoming decoupled from its respective shank 102. Such a determination of the loss of a given point 104 or other shank attachment member would be indicative of a change in the installation status of such shank attachment member.

Moreover, at 306, the method 300 may include initiating a control action when it is determined that a change in the installation status of the shank attachment member has occurred. For example, as indicated above, the computing system 202 may be configured to initiate one or more control actions (e.g., one or more implement-based and/or vehicle-based control actions) in response to determining that the installation status of a given shank attachment member has occurred. Suitable control actions may include, but are not limited to, providing the operator with an indication of the installation status of the shank attachment member (e.g., via the user interface 212 and/or associated display 214), controlling the operation of one or more components of the implement 10 (e.g., the frame actuators 14A), controlling the operation of one or more components of the vehicle towing the implement 10 (e.g., one or more drive members 218) and/or the like.

It is to be understood that, in several embodiments, the steps of the method 300 are performed by the computing system 202 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, in several embodiments, any of the functionality performed by the computing system 202 described herein, such as the method 300, is implemented in software code or instructions which are tangibly stored on a tangible computer readable medium. The computing system 202 loads the software code or instructions via a direct interface with the computer readable medium or via a wired and/or wireless network. Upon loading and executing such software code or instructions by the computing system 202, the computing system 202 may perform any of the functionality of the computing system 202 described herein, including any steps of the method 300 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for monitoring the installation status of shank attachment members of an agricultural implement, the system comprising:
a shank assembly including a shank extending between a proximal end and a distal end opposite the distal end, the proximal end of the shank being configured to be coupled to a portion of the agricultural implement, the shank assembly further comprises a shank attachment member configured to be coupled to the distal end of the shank;
a load sensor provided in operative association with the shank assembly and being configured to generate data indicative of a load transmitted through the shank assembly; and
a computing system communicatively coupled to the load sensor, the computing system configured to determine an installation status of the shank attachment member relative to the shank based on the data received from the load sensor.

2. The system of claim 1, wherein the shank assembly further comprises attachment structure coupling the proximal end of the shank to the portion of the agricultural implement, the load sensor being provided at a connection point between the shank and the attachment structure.

3. The system of claim 2, wherein the shank is coupled to the attachment structure at a pivot point, the load sensor being provided at the pivot point to generate data indicative of the load being transmitted through the shank assembly at the pivot point.

4. The system of claim 3, wherein the load sensor comprises one of a load pin, a load cell, or a strain gauge installed at the pivot point.

5. The system of claim 1, wherein the computing system is configured to determine the installation status of the shank attachment member based on load variations in the load transmitted through the shank assembly.

6. The system of claim 5, wherein the load variations comprise variations in at least one of a magnitude or a direction of the load transmitted through the shank assembly.

7. The system of claim 1, wherein the shank assembly is movable between a raised position at which the attachment member is configured to be located above a surface of the ground and a lowered position at which the attachment member is configured to be located below the surface of the ground, the computing system being configured to determine the installation status of the shank attachment member when the shank assembly is at the raised position or the lowered position based on load variations in the load transmitted through the shank assembly.

8. The system of claim 1, further comprising a user interface in communication with the computing system, the computing system being configured to indicate the installation status of the shank attachment member to an operator of the agricultural implement via the user interface.

9. The system of claim 1, wherein the computing system is configured to adjust an operation of the agricultural implement based at least in part on the installation status of the shank attachment member.

10. The system of claim 1, wherein the shank attachment member comprises a shank point.

11. An agricultural implement, comprising:
a frame;
a plurality of shank assemblies supported relative to the frame, each of the plurality of shank assemblies comprising:
a shank extending between a proximal end and a distal end opposite the distal end, the proximal end of the shank being configured to be coupled to the frame; and
a shank attachment member configured to be coupled to the distal end of the shank;
a load sensor provided in operative association with a respective shank assembly of the plurality of shank assemblies and being configured to generate data indicative of a load transmitted through the respective shank assembly; and
a computing system communicatively coupled to the load sensor, the computing system configured to determine an installation status of the shank attachment member of the respective shank assembly based on the data received from the load sensor.

12. The agricultural implement of claim 11, wherein the respective shank assembly further comprises attachment structure coupling the proximal end of the shank to the frame the load sensor being provided at a connection point between the shank and the attachment structure.

13. The agricultural implement of claim 12, wherein the shank is coupled to the attachment structure at a pivot point, the load sensor being provided at the pivot point to generate data indicative of the load being transmitted through the respective shank assembly at the pivot point.

14. The agricultural implement of claim 11, wherein the computing system is configured to determine the installation status of the shank attachment member based on load variations in the load transmitted through the respective shank assembly.

15. The agricultural implement of claim 14, wherein the load variations comprise variations in at least one of a magnitude or a direction of the load transmitted through the respective shank assembly.

16. The agricultural implement of claim 11, further comprising a user interface in communication with the computing system, the computing system being configured to indicate the installation status of the shank attachment member to an operator of the agricultural implement via the user interface.

17. The agricultural implement of claim 11, wherein the computing system is configured to adjust an operation of the agricultural implement based at least in part on the installation status of the shank attachment member.

18. A method for monitoring the installation status of a shank attachment member of an agricultural implement, the agricultural implement comprising a shank assembly including a shank and a shank attachment member configured to be coupled to the shank, the method comprising:
receiving, with a computing system, data indicative of a load being transmitted through the shank assembly;
determining, with the computing system, when a change in the installation status of the shank attachment member occurs based on the data; and
initiating, with the computing system, a control action when it is determined that a change in the installation status of the shank attachment member has occurred.

19. The method of claim 18, wherein initiating the control action comprises indicating the change in the installation status of the shank attachment member to an operator of the agricultural implement.

20. The method of claim 18, wherein initiating the control action comprises adjusting an operation of the agricultural implement when it is determined that a change in the installation status of the shank attachment member has occurred.
